(19) United States
(12) Patent Application Publication
(10) Pub. No.: US 2007/0205073 A1
(43) Pub. Date: Sep. 6, 2007

(54) Clutch release device for a friction clutch of a motor vehicle with a multi-part sliding sleeve

(75) Inventors: Thomas Otto, Schweinfurt (DE); Herbert Voit, Schweinfurt (DE); Manfred Wehner, Euerbach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/713,296

(22) Filed: Mar. 2, 2007

(30) Foreign Application Priority Data
Mar. 3, 2006 (EP) 06 004 318.9

(51) Int. Cl. F16D 23/14

(52) U.S. Cl. 192/98; 192/110 B

(57) ABSTRACT

A clutch-release device for a friction clutch of a motor vehicle includes a guide tube and a sliding sleeve, which is free to shift position axially on the tube, the sleeve having a contact area for absorbing the actuating force of an actuating element. A clutch-release bearing is mounted on the sliding sleeve, the bearing having a nonrotatable first bearing ring, rolling elements, and a rotating second bearing ring, which is in working connection with an actuating element of the friction clutch. To increase the number of identical parts and thus to reduce costs, the sliding sleeve has a multi-part design, thus representing an assembly having at least two parts.

### BACKGROUND OF THE INVENTION

1. Field of the Invention

The present invention pertains to a clutch-release of the type including a guide tube; a sliding sleeve which can move axially on the guide tube; and a clutch release bearing mounted coaxially on the sliding sleeve, the clutch release bearing having a first bearing ring which is mounted nonrotatably with respect to the sliding sleeve, and a second bearing ring which is rotatable with respect to the first bearing ring and can make working contact with the friction clutch.

2. Description of the Related Art

A clutch-release device of this type for actuating a motor vehicle friction clutch, as described in, for example, DE 197 00 930 A1, requires an individual configuration for each vehicle platform. This means that the clutch-release device, depending on the technical specifications of the clutch, must be specially designed and dimensioned for the release forces required to actuate it and for the space available for it in the drive train. In particular, the given length between the contact areas of the clutch lever or clutch fork and the action point of the clutch actuating element, e.g., the ends of the tongues of a diaphragm spring; the inside diameter of the sliding sleeve; and the width of the contact area of the clutch lever on the sliding sleeve can vary. For example, a plurality of different sliding sleeves which differ only with respect to their installation length may be required so that clutch-release devices of different installation lengths can be made available, even if the inside diameter of the sliding sleeve is the same, the width of the contact areas for the clutch lever is the same, and the geometry of the clutch-release bearing is the same. This means that a large number of individual parts must be manufactured, which is associated with a high tool cost.

### SUMMARY OF THE INVENTION

Against the background of this problem, the task of the invention is to provide a clutch-release device which reduces the variety of parts and thus lowers the associated cost.

The inventive solution thus provides a clutch-release device for a friction clutch of a motor vehicle which comprises, first, a guide tube and a sliding sleeve, which can shift position axially on the tube, the sleeve having a contact area for absorbing the actuating force of an actuating element. A clutch-release bearing with a first bearing ring, which is nonrotatable with respect to the sleeve; rolling elements; and a rotating second bearing ring, which is in working connection with an actuating element of the friction clutch, are mounted coaxially on the sliding sleeve. In the inventive clutch-release bearing, the sliding sleeve has a multi-part design.

The sliding sleeve is thus divided structurally into a first component part, which is the same for several different release device designs, and a second component part, which is different for each of the several different release device designs. This means that an inventive clutch-release device comprises in this case a first sliding sleeve part, which is the same for all of the different types of release devices. This part is assembled with a second sliding sleeve part, which is different depending on the actual given circumstances. It is true that, to prepare “n” different release devices, it is therefore necessary to have n+1 different sliding sleeve parts, but the tool and production costs required for this can be more favorable than those for the fabrication of n different one-piece sliding sleeves.

With the proposed solution, it is now possible in particular to accommodate the variations in the inside diameter of the guide sleeve and/or in the width of the contact area of the clutch lever and/or in the installation length present in different release devices simply by configuring one of the two parts of the sliding sleeve appropriately, whereas the other part of the sleeve can remain the same in all cases.

Of course, the inventive, multi-part design of the sliding sleeve is not limited to a two-part design; on the contrary, a sliding sleeve can also be assembled from three or even more parts. In this way, a building-block system for the preparation of various clutch-release devices is provided, where a large number of identical parts can be used.

So that the guide tube can have the greatest possible length for guiding the release device, it has been found favorable to arrange the parts of the sliding sleeve radially with respect to each other. The sliding sleeve in this case comprises an inner part, mounted on the guide tube, and an outer part, which is supported on the inner part. The two parts have axial contact surfaces, by which the parts rest axially against each other. It is thus possible to realize a specific installation length of the clutch-release device by adjusting the axial position of the contact surfaces as required.

For practical reasons, it has been found helpful for one of the parts to comprise a bearing flange for the mounting of the clutch-release bearing and for the other part to comprise a contact area for absorbing the actuating force of the actuating element.

The designs in the past have pertained to release devices in which two or even more parts are used to produce exactly one specific type of sliding sleeve with a previously determined total length. But if several, that is, at least two types, of axially graduated contact surfaces, distributed around the circumference, are formed on at least one of the sliding sleeve parts, then, upon the assembly of, for example, two sliding sleeve parts, the parts can be rotated to assume a specific rotational position with respect to each other so that only one type of graduated actuating surface on the first sliding sleeve part will be brought into contact with the opposing contact surface formed on the other part. In this way, depending on the number of different axial graduations or different types of contact surfaces, a plurality of sliding sleeves or release devices which differ with respect to their installation lengths can be produced from two or more sliding sleeve parts as desired.

It is advantageous to form the graduated contact surfaces in pairs, where the contact surfaces belonging to one pair are designed opposite each other with respect to the center axis of the sliding sleeve part in question.

According to another advantageous embodiment, an antitwist device is provided on the sliding sleeve parts, as a result of which their rotational position with respect to each other is secured during assembly and locked in place. This can be done easily by providing the graduated contact surfaces and the opposing contact surfaces cooperating with them with appropriate geometries or by using additional means such as for example, providing axial extensions on one of the parts and bores in the other part, into which the extensions fit.

It is advisable to provide axial locking means on the sliding sleeve parts; these locking means lock the parts together in a captive manner after they have been assembled. In principle, any measures known to a person skilled in the art are suitable for this purpose, especially tool-free connecting techniques such as latching or snap-in connections, which can be designed either as detachable connections or as single-use connections.

The antitwist device and the axial locking means are preferably designed in common, in that for example, latching hooks are provided in the area of the contact surfaces.

The parts of the sliding sleeve can preferably be made of a heat-resistant plastic such as polyamide by injection-molding.

In addition, the proposed solution also yields numerous advantageous installation options. The clutch-release device can, for example, be preassembled by the supplier and delivered as a finished product to the vehicle manufacturer. There is also the other possibility, however, that the clutch-release device could be delivered to the customer as unassembled components. The customer himself would then decide how to assemble the sliding sleeve and thus the clutch-release device on the basis of the specific vehicle to be built. Because one of the sliding sleeve parts can be made available with different dimensions, this variant also makes it possible to compensate effectively for manufacturing tolerances at the assembly site. Advantage can also be taken of the multi-part design of the sliding sleeve to compensate for the displacement of the clutch-release stroke which occurs as the clutch lining wears down. While the vehicle is in the garage for service, the multi-part sliding sleeve of the clutch-release device can be removed and then reinstalled after being given a new, different installation length. There is also the possibility of keeping the part of the sliding sleeve which remains functional and of replacing the worn-out part.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1a-1c show axial cross sections through a clutch-release device with a two-part sliding sleeve, comprising an inner sleeve which remains the same in all cases and a bearing carrier, which is different in each case;

FIG. 2 shows perspective views of the two separate parts of a sliding sleeve and of the assembled unit; and

FIGS. 3a-3e show perspective views of the two parts of a sliding sleeve which can be assembled to produce 3 different lengths by being turned to different rotational positions with respect to each other.

### DETAILED DESCRIPTION OF THE PRESENTLY PREFERRED EMBODIMENTS

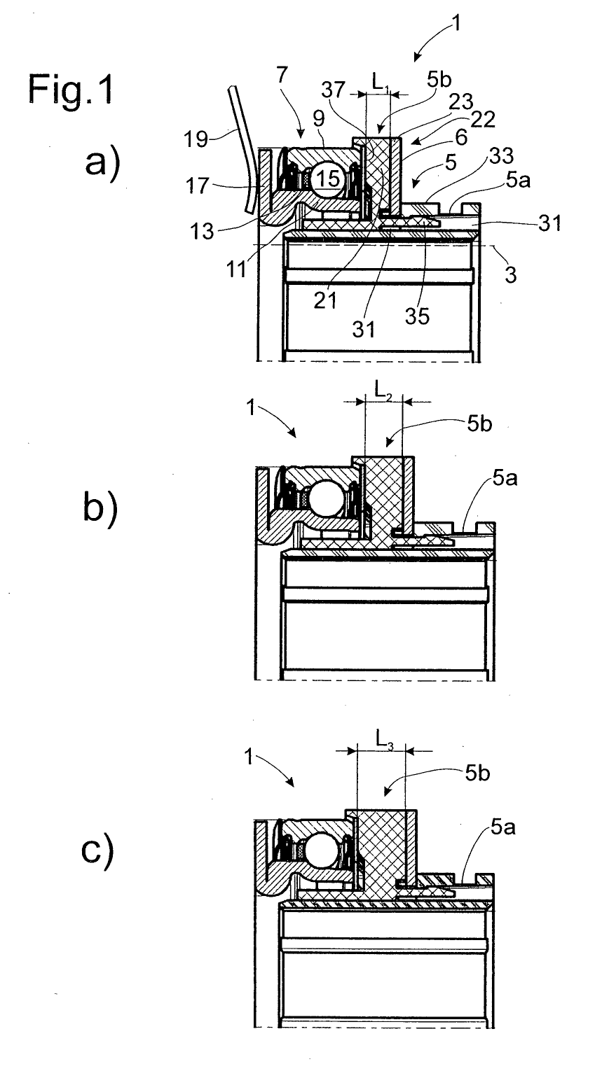

FIG. 1 shows an axial cross section of three variants of a clutch-release device 1, all of the same basic design, for a friction clutch of a motor vehicle. The device has a guide tube 3, indicated in FIG. 1a in broken line, and a sliding sleeve 5, which is able to shift position axially on the tube and which has a contact area 6 for a clutch lever, serving as the actuating element, by means of which the actuating force can be introduced to the clutch-release device 1.

The sliding sleeve 5 carries a clutch-release bearing 7 mounted coaxially on it. The bearing has an outer ring 9, mounted nonrotatably with respect to the sliding sleeve; rolling elements 15, located in a bearing cage 13; and a rotating inner bearing ring 11. The inner ring is extended in the axial direction to form a radial flange 17, on which an actuating element 19, such as a diaphragm spring, of a friction clutch (not shown in the drawing), can act to apply a releasing force.

It can be seen that the sliding sleeve 5 is made up of several parts, comprising a sleeve-like inner part 5a mounted on the guide tube 3 and an outer part 5b, indicated by crosshatching in FIG. 1, which is supported on the inner part. Both of these parts are made of a polyamide material. The outer part 5b has a sleeve section 20 and a radially projecting, disk-shaped bearing flange 21, to which the stationary outer ring 9 of the clutch-release bearing 7 is attached by means of several retaining clamps, not visible in FIG. 1, distributed around the circumference.

Two contact areas 6 for a clutch lever or fork are formed opposite each other on the circumference of the inner part 5a, for which purpose a ring-shaped sheet-steel disk 22 with two radially outward-extending projections 23 is clamped axially and radially on the inner part 5a.

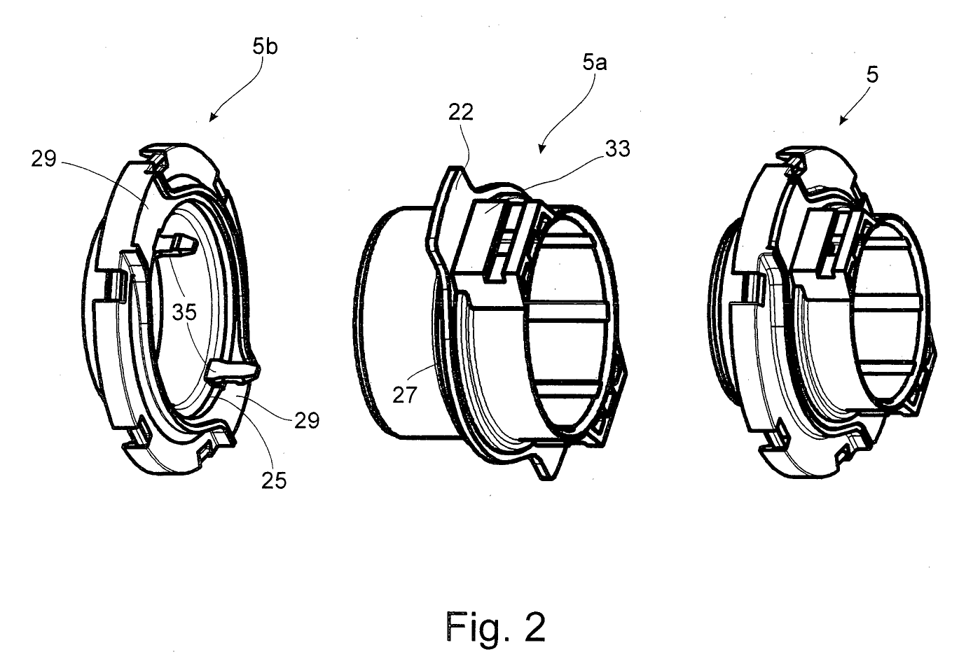

To install the sliding sleeve 5, as shown in FIG. 2, the outer part 5b is pushed over the inner part 5a, where the two parts 5a, 5b rest axially against each other by their contact surfaces 25, 27, formed on the inner diameter of the sleeve section 20 and on the outer diameter of the inner part 5a. On the side of the bearing flange 21 facing away from the clutch-release bearing 7, recesses 29 are formed, into which the two contact areas 23 for the clutch lever can positively engage and thus form a first antitwist device. So that the two parts 5a, 5b of the sliding sleeve are held in place with respect to each other, axial openings 31, which pass through radial shoulders 33 on the inner part 5a, which is made of plastic, are provided on the inner part 5a, or, more precisely, at the inside circumference of the sheet-steel disk 22, in the area of the contact surfaces 6. Two corresponding latching tongues 35 are formed on the outer part 5b. These tongues engage in the previously mentioned openings 31 and have an undercut, which can lock in position there, as a result of which the two parts 5a, 5b are captured axially and also prevented from rotating with respect to each other.

The clutch-release devices 1 shown in FIGS. 1a-1c differ through the use of different outer parts 5b, in which the length Lₓ of the bearing flange 21 is varied with x=1, 2, 3, which defines the axial distance of the contact surface 37 for the clutch-release bearing 7 from the contact surface 6 on the sheet-steel disk 22. The inner parts 5a are of the same design, so that three different clutch-release devices 1 can be made out one inner part 5a and three different outer parts 5b.

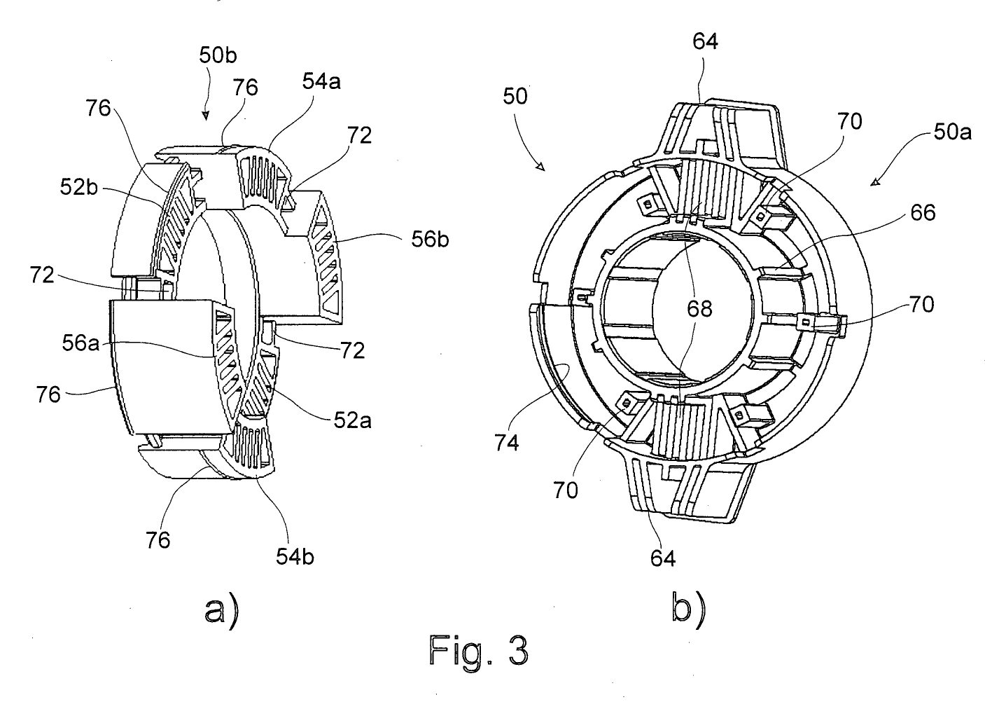

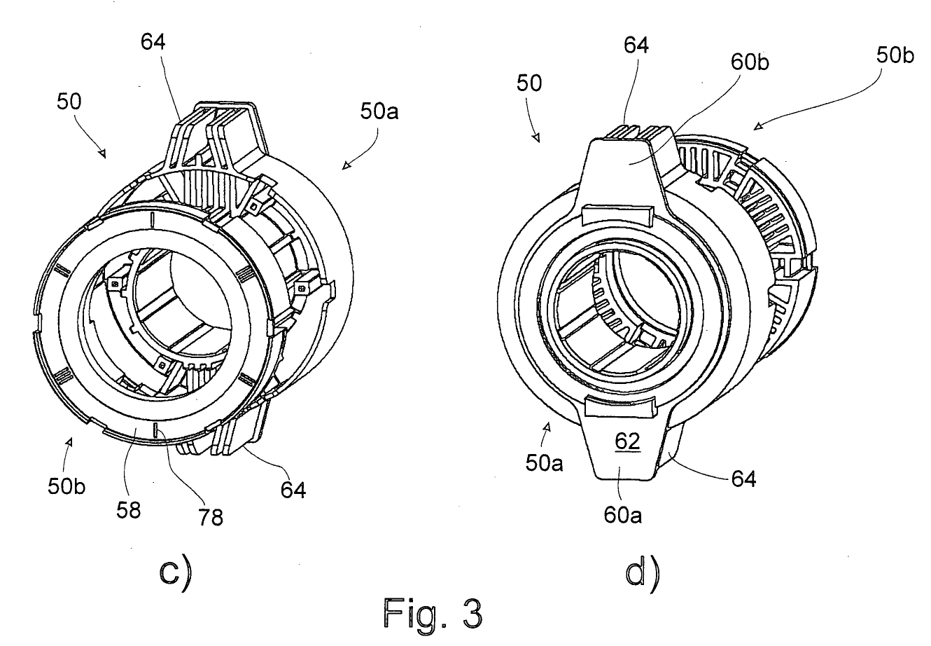

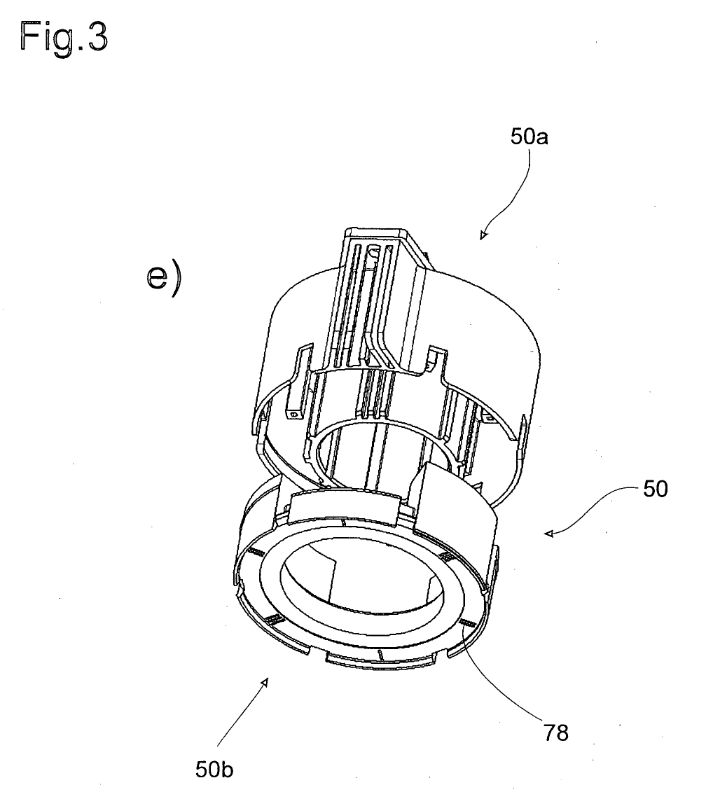

FIGS. 3a-3e show another sliding sleeve 10 consisting of two parts 50a, 50b, where three different variants of a sliding sleeve 10 can be prepared by assembling them with different orientations with respect to each other. FIG. 3a shows a ring-shaped bearing carrier, formed as the outer part 50b, on which axially graduated contact surfaces 52a, 52b; 54a, 54b; 56a, 56b are formed in pairs, the surfaces of each pair being opposite each other with respect to the center axis of the part 50b. The opposing surface 58 (FIG. 3c) is essentially flat and serves to accept a clutch-release bearing (not shown here), which is fastened to the outer part by clamps, which engage in openings.

The inner part 50a is designed in its basic form as a double-walled, tubular cylinder, closed at one end, with an inner tube section 502 and an outer tube section 504. The contact area 62 for a clutch lever (FIG. 3d) is, as in the case of the example explained on the basis of FIGS. 1 and 2, formed by a ring-shaped sheet-steel disk 22 with two radially outward-extending projections 60a, 60b. The disk 22 is held axially and radially on the inner part 50a and is supported in the area of the projections 60a, 60b by an outer rib structure 64, formed on the outer circumferential surface of the outer tube section 504.

The inner tube section 502 has axial ribs 66 distributed around its outer circumference; the radial ends of these ribs form a reference circle with a diameter which is slightly smaller than that of the outer part 50b of the sliding sleeve, so that the outer part can fit over it. In the area of the outer rib structure 64, two web structures 68 are formed radially between the inner (502) and the outer (504) tube section; these structures provide two contact surfaces within the axial dimension of the inner part 50a for cooperating with one of the pairs of graduated contact surfaces 52a, 52b; 54a, 54b; 56a, 56b of the outer part 50b.

To assemble the sliding sleeve 10, the outer part 50b is pushed axially over the inner tube section 502 of the inner part 50a, where, through the appropriate selection of the relative rotational position of the parts 50a, 50b, it is determined which of the pairs of graduated contact surfaces 52a, 52b; 54a, 54b; 56a, 56b will come to rest against the opposing contact surfaces 68 of the inner part 50a (FIG. 3b). To hold the parts in the rotational position thus assumed, several axial pins 70 are provided on the inner part 50a between the inner 502 and the outer 504 tube section. These pins fit into corresponding openings 72 in the outer part 50b. The axial locking of the parts 50a, 50b is accomplished by means of a detachable snap-in connection, which comprises two snap-in grooves 74 on two opposite sectors of the inside circumferential surface of the outer tube section 504 and snap-in beads 76 on the outer part 50b, consisting of several segments corresponding to the graduated contact surfaces 52a, 52b; 54a, 54b; 56a, 56b, the axial position of the bead on one pair of contact surfaces 52a, 52b; 54a, 54b; 56a, 56b being different from that of the other beads on the other surfaces. This means that, depending on the rotational position of the parts 50a, 50b, the snap-in groove 74 cooperates with only one pair 76 of snap-in beads.

For the sake of better illustration, FIGS. 3c-3d show the positional arrangement of the inner 50a and outer part 50b with respect to each other during assembly. To facilitate the assembly process, the outer part 50b has a bar code 78, visible from the outside, on the end surface facing axially away from the inner part 50a. This code corresponds to the graduated contact surfaces 52a, 52b; 54a, 54b; 56a, 56b and is also marked in pairs. During installation, the code can be brought into alignment with a marking such as a pointer or a design feature or a significant point on the inner part 50a, such as the projections 64.

The parts 50a, 50b are again made of a heat-resistant plastic and are also provided with openings in several places to avoid excessive accumulations of material.

Alternatively or in addition, the multi-part design of the sliding sleeve can be used not only to vary the length of the sleeve, as explained on the basis of FIGS. 1-3, but also to vary the diameter by the use of one or more corresponding adapter sleeves so that the sleeve can fit on guide tubes of different diameters, for example.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch release device comprising:
a guide tube;
a sliding sleeve which can move axially on the guide tube, the sliding sleeve comprising at least two parts, one of said parts having a contact area which comes into contact with a clutch release lever; and
a clutch release bearing mounted coaxially on the sliding sleeve, the clutch release bearing having a first bearing ring which is mounted nonrotatably with respect to the sliding sleeve, and a second bearing ring which is rotatable with respect to the first bearing ring and can make working contact with the friction clutch.

2. The clutch release device of claim 1 wherein the sliding sleeve comprises an inner part, which is mounted on the guide tube, and an outer part, which is supported on the inner part, each of the parts having an axial contact surface which bears against the axial contact surface of the other part.

3. The clutch release device of claim 2 wherein one of said inner and outer parts comprises a bearing flange on which the first bearing ring is mounted, and the other of said parts comprises the contact area which comes into contact with a clutch release lever.

4. The clutch release device of claim 1 wherein one of said sliding sleeve parts comprises at least two first contact surfaces which are at different axial levels with respect to each other, the other said sliding sleeve part comprising a second contact surface, wherein a selected one of said first contact surfaces can be brought into contact with said second surface by rotating the sliding sleeve parts to a selected relative angular orientation.

5. The clutch release device of claim 4 wherein said first contact surfaces are formed in diametrically opposed pairs, the first contact surfaces in each pair being at the same axial level, the second sliding sleeve part comprising a pair of diametrically opposed second contact surfaces which are at the same axial level.

6. The clutch release device of claim 1 further comprising means for preventing relative rotation of the sliding sleeve parts from a selected angular orientation when said
parts are assembled together.

7. The clutch device of claim 1 further comprising means for locking said sliding sleeve parts together axially.

8. The clutch device of claim 6 said means for locking said sliding sleeve parts together axially also prevents relative rotation of said sliding sleeve from a selected angular orientation when said parts are assembled together.

9. The clutch release device of claim 1 wherein said sliding sleeve parts are made of heat-resistant plastic.

10. The clutch release device of claim 4 wherein at least one of said parts has an external marking which aids in selecting a relative angular orientation of the parts.
